(19) United States
(12) Patent Application Publication
(10) Pub. No.: US 2011/0128422 A1
(43) Pub. Date: Jun. 2, 2011

(54) IMAGE CAPTURING APPARATUS AND IMAGE PROCESSING METHOD

(75) Inventor: Toru Nagata, Tokyo (JP)

(73) Assignee: CANON KABUSHIKI KAISHA, Tokyo (JP)

(21) Appl. No.: 12/950,607

(22) Filed: Nov. 19, 2010

(30) Foreign Application Priority Data
Nov. 30, 2009 (JP) 2009-272803

(51) Int. Cl. H04N 5/217

(52) U.S. Cl. 348/241; 348/E05.078

(57) ABSTRACT

An image capturing apparatus calculates the frequency component of each pixel of a captured image and divides the pixels into pixels in a recovery region, whose frequency components are equal to or more than a predetermined threshold, and other pixels in a non-recovery region. A recovery unit performs recovery processing for each pixel in the recovery region to correct the degradation of image quality caused by the optical characteristics of the image capturing unit. The recovery processing unit does not perform recovery processing for the pixels in the non-recovery region. The image capturing apparatus reconstructs the captured image by combining the pixels in the recovery region for which the recovery processing has been performed with the pixels in the non-recovery region. This makes it possible to suppress degradation of image quality in a region which does not match a recovery filter in terms of focal length.

### BACKGROUND OF THE INVENTION

1. Field of the Invention

The present invention relates to an image capturing apparatus and image processing method in which the degradation of image quality caused by the optical characteristics of an image capturing system is improved by image recovery.

2. Description of the Related Art

As a method of correcting the degradation of blur components in a captured image, there is known a correction method using the optical transfer function (OTF) information of an objective lens. This method is generally referred to as “image recovery” or “image restoration”, and hence correction processing by this method will be described as “image recovery” or more simply described as “recovery”.

Since the OTF of the imaging lens changes depending on the focusing distance, the recovery filter generated based on the OTF and applied to image recovery processing also varies depending on the focusing distance of the imaging lens. Therefore, there is an optimal object distance for the recovery filter. If recovery processing is performed for an object in spite of the fact that the object is an out-of-focus object whose object distance does not match the recovery filter, degradation of image quality, such as the generation of false colors, occurs.

The principle of the generation of false colors will be briefly described below. In general, an image capturing optical system has an axial chromatic aberration characteristic in that the focal point shifts along the optical axial for each wavelength, that is, each color component. Consider an object having different object distances for its respective portions, for example, a 3D object. In this case, the focal points of the respective colors change with respect to an image sensor in accordance with the respective portions. In a captured image of the object, color blur occurs at an edge portion in accordance with the axial chromatic aberration characteristic. This blur further changes before and after the focusing distance. When such an image is recovered by using an image recovery filter in accordance with a given focusing distance, the recovery degree of each color component unexpectedly changes, and the change in color blur increases, resulting in the generation of a false color at the edge portion.

The generation of such false colors can be prevented by not using an improper recovery filter that does not match the object distance. For example, the following techniques are known. First of all, there is disclosed a technique of matching a recovery filter with the distance to each portion of an object by measuring the object distance and performing recovery using different filters respectively matching the measured object distances (see, for example, Japanese Patent Laid-Open No. 2002-112099). In addition, there is disclosed a technique of regarding a specific region of a target object within a frame as an object region to be brought into focus in accordance with the shape of the object if the shape is constant, and recovering only the specific region (see, for example, Japanese Patent Laid-Open No. 10-165365). Furthermore, there is disclosed a technique in which in order to extract an in-focus portion on an object, gradients are calculated by differential processing for the object, and a portion with a large gradient is recovered (see, for example, Japanese Patent Laid-Open No. 2002-300461).

In the above techniques, degradation of image quality, more specifically the generation of false colors, is prevented by controlling against the use of an improper filter which does not match the object distance. However, these techniques have the following problems.

First of all, according to the technique of measuring an object distance, measuring accurate object distances in all of the regions within a frame will increase the physical size and cost of an image capturing unit. The technique of determining an in-focus region on the assumption that an object has a specific shape, cannot be applied to general captured images. According to the technique of recovering a region of an object which has a high gradient value, a region with a low contrast and a high spatial frequency component, which is a portion to be recovered, is excepted from recovery targets.

### SUMMARY OF THE INVENTION

The present invention provides an image capturing apparatus and image processing method which perform, with a simple arrangement, recovery processing only for proper regions in a captured image to suppress the degradation of image quality in other regions.

According to one aspect of the present invention, an image capturing apparatus comprises an image sensing unit configured to obtain a captured image by capturing an image of an object, a dividing unit configured to calculate a frequency component of each pixel of the captured image and divide the pixels into pixels in a recovery region, whose frequency components are not less than a predetermined threshold, and other pixels in a non-recovery region, a recovery unit configured to perform recovery processing for a pixel in the recovery region to correct degradation of image quality caused by optical characteristics of the image sensing unit, and a combining unit configured to reconstruct the captured image by combining pixels in the recovery region for which the recovery processing has been performed with pixels in the non-recovery region.

Further features of the present invention will become apparent from the following description of exemplary embodiments (with reference to the attached drawings).

### BRIEF DESCRIPTION OF THE DRAWINGS

FIG. 1 is a block diagram showing the arrangement of an image capturing apparatus according to an embodiment;

FIG. 2 is a block diagram showing the detailed arrangement of an image recovery unit and its associated portion according to the embodiment;

FIG. 3 is a flowchart showing image recovery processing in the embodiment;

FIGS. 4A and 4B are views each showing an example of a Gaussian filter used for high-frequency component calculation in the embodiment;

FIG. 5 is a view for explaining the effects obtained by recovery processing in the embodiment; and

FIG. 6 is a view showing an example of a threshold adjustment GUI to be used at the time of the determination of a high-frequency component in the embodiment.

### DESCRIPTION OF THE EMBODIMENTS

The embodiments of the present invention will be described below with reference to the accompanying drawings. The following embodiments do not limit the present invention of the appended claims, and not all combinations of characteristic features described in the embodiments are essential to the solving means of the present invention.

### First Embodiment

### Apparatus Arrangement

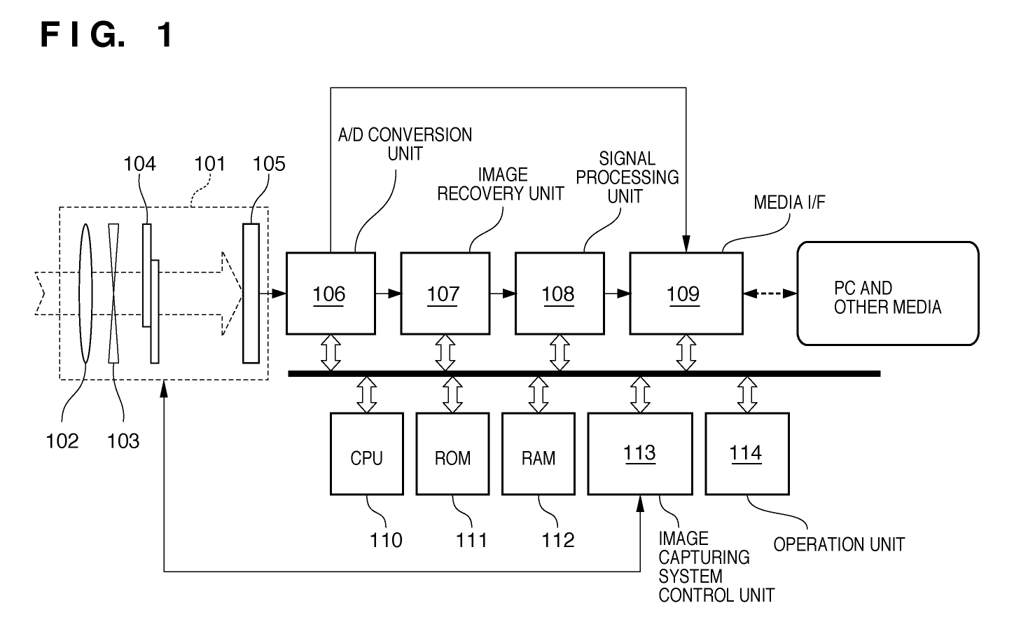

FIG. 1 is a block diagram showing the arrangement of an image capturing apparatus according to this embodiment. Referring to FIG. 1, reference numeral 101 denotes an image capturing unit which detects the amount of light on an object and includes the following units. That is, in the image capturing unit 101, reference numeral 102 denotes an objective lens; 103, an aperture; 104, a shutter; and 105, an image sensor such as a CMOS or CCD sensor. Assume that the image sensor 105 according to this embodiment is provided with R, G, and B pixels in a general Bayer arrangement.

Reference numeral 106 denotes an A/D conversion unit to convert an analog signal generated in accordance with the amount of light entering to each pixel of the image sensor 105 into a digital value. The A/D conversion unit 106 also generates a raw image in which the Bayer arrangement of the respective R, G, and B pixels remains the same. Reference numeral 107 denotes an image recovery unit which is a feature of this embodiment and processes the raw image to recover blur in the image which is caused by the optical characteristics of the imaging lens 102 at the time of image capturing. Note that the details of image recovery processing in the image recovery unit 107 will be described later.

Reference numeral 108 denotes a signal processing unit to generate a digital image by performing various kinds of image processing such as de-mosaic processing, white balance processing, and gamma processing for the raw image described above. Reference numeral 109 denotes a media interface which is connected to a PC and other media (for example, a hard disk, memory card, CF card, SD card, and USB memory) to send out digital images to the media.

Reference numeral 110 denotes a CPU which is associated with all the processes in the respective arrangements of the image capturing apparatus of this embodiment, sequentially reads and interprets instructions stored in a ROM 111 and RAM 112, and executes the respective processes in accordance with the interpretation results. The ROM 111 and the RAM 112 provide the CPU 110 with programs, data, work areas, and the like necessary for the processes. Reference numeral 113 denotes an image capturing system control unit to control the image capturing system including the focus, shutter, and aperture based on instructions from the CPU 110; and 114, an operation unit which comprises buttons, a mode dial, and the like, through which it receives user input instructions.

With the above arrangement, the image capturing apparatus of this embodiment acquires a digital image constituted by R, G, and B pixels. Image capturing processing for digital images is the same as image capturing with a general digital camera, and hence a description of the processing will be omitted.

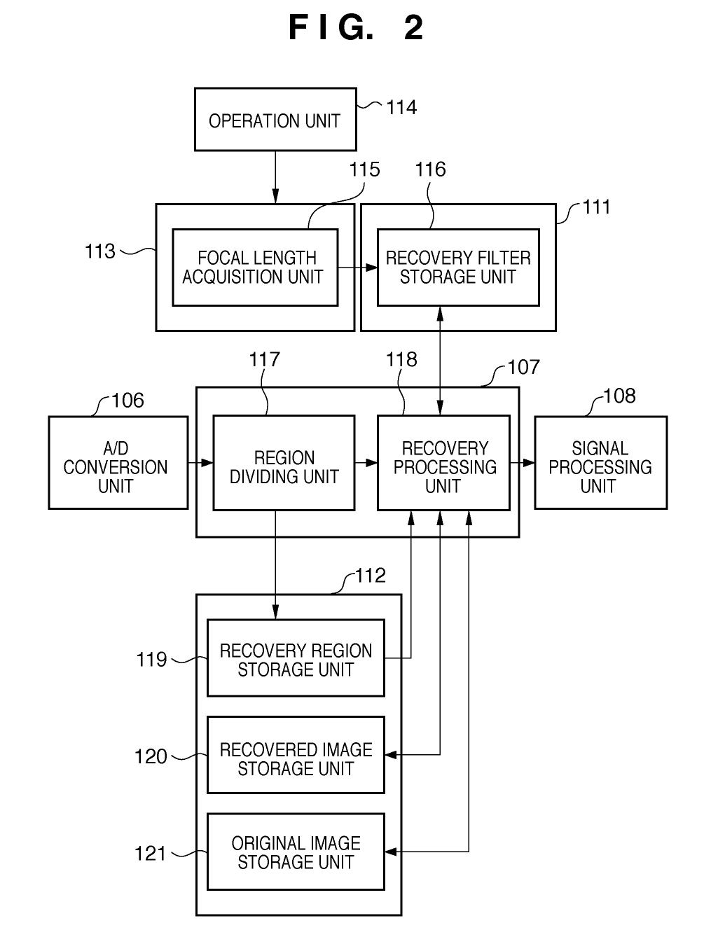

According to the feature of the image capturing apparatus of this embodiment, the image recovery unit 107 performs image recovery processing for a captured image. FIG. 2 shows portions particularly associated with image recovery, which are extracted from the arrangement shown in FIG. 1, and their detailed arrangements. The reference numerals in FIG. 1 are used to denote the same parts in FIG. 2, and descriptions of these will be omitted.

Referring to FIG. 2, when the user presses the shutter release button as part of the operation unit 114, the image capturing system control unit 113 performs focus adjustment by driving the objective lens 102 using an autofocus mechanism (not shown).

Reference numeral 115 denotes a focusing distance acquisition unit to acquire the distance set upon focus adjustment by the autofocus mechanism of the image capturing system control unit 113 and to output the focusing distance in accordance with the position of the objective lens 102; and 116, a recovery filter storage unit in the ROM 111. The recovery filter storage unit 116 holds a plurality of recovery filters based on the optical transfer function (OTF) which changes in accordance with parameters such as a focusing distance, aperture value, and image height. The recovery filter storage unit 116 receives afocusing distance, aperture value, and image height from the focusing distance acquisition unit 115, the image capturing system control unit 113, and the image recovery unit 107 respectively, and outputs a recovery filter matching them to the image recovery unit 107. Note that the details of recovery filters in this embodiment will be described later.

The characteristics of the objective lens 102 determine parameters associated with the change of a recovery filter. The recovery filter therefore changes in accordance with a plurality of parameters (for example, all parameters) such as afocusing distance, aperture value, and image height, or can change in accordance with, for example, only a focusing distance. That is, it is possible to use matched filters to focusing distances or a single filter for all conditions. Note that the user can manually set these parameters via a GUI or the like.

The A/D conversion unit 106 transfers image information, captured concurrently with the above distance determination and filter output operation, as a raw image to the image recovery unit 107. The image recovery unit 107 is roughly divided into two arrangements. Reference numeral 117 denotes a region dividing unit to divide an image into a region to be subjected to recovery and a region not to be subjected to recovery; and 118, a recovery processing unit to perform image recovery for a region to be subjected to recovery by applying a recovery filter to it. The recovery processing unit 118 also combines an image after recovery with an original image of a region having undergone no recovery. This combining operation will generate a raw image again, which is output to the signal processing unit 108. The details of recovery processing in the recovery processing unit 118 will be described later.

The RAM 112 temporarily stores information necessary during processing. Reference numeral 119 denotes a recovery region storage unit to hold the region division result obtained by the region dividing unit 117; 120, a recovered image storage unit to store the image after the recovery of a recovery region which is output from the recovery processing unit 118; and 121, an original image storage unit to store the original image of a region having undergone no recovery. The recovered image storage unit 120 and the original image storage unit 121 return all the pieces of image information to the recovery processing unit 118 at the end of processing for the entire image.

(Image Recovery Processing)

Image recovery processing in the recovery processing unit 118 in this embodiment will be described below. As described above, image recovery processing is the processing of correcting the degradation of image quality caused by the optical characteristics of the image capturing system for the captured image.

Letting g(x, y) be a degraded image, f(x, y) be an original image, and h(x, y) be a point spread function (PSF) as a Fourier pair of the OTF of the objective lens 102, equation (1) given below holds:

g(x,y)=h(x,y)*f(x,y) (1)

where * represents convolution, and (x, y) represents coordinates on the image.

When equation (1) is Fourier-transformed into a form in the frequency domain, the equation is expressed by the product form of the respective frequencies like equation (2) given below. In equation (2), H represents the value obtained by Fourier transform of h which is PSF in equation (1), that is, OTF, and G and F respectively represent the values obtained by Fourier transform of g and f. In addition, (u, v) represents coordinates in the two-dimensional frequency domain, that is, a frequency.

G(u,v)=H(u,v)·F(u,v) (2)

In this case, in order to obtain an original image from a captured degraded image, both the right- and left-hand sides of equation (2) are divided by H, as indicated by equation (3) given below:

G(u,v)/H(u,v)=F(u,v) (3)

Inverse-Fourier-transforming F(u, v) in equation (3), that is, G(u, v)/H(u, v), into the function in the spatial domain will obtain the original image f(x, y) as a recovered image. Let r be the value obtained by inverse Fourier transform of 1/H(u, v). This transforms equation (3) into equation (4) given below. According to equation (4), convolution of an image in the spatial domain can acquire the original image. The function r(x, y) in equation (4) represents the above recovery filter.

g(x,y)*r(x,y)=f(x,y) (4)

According to the feature of this embodiment, recovery processing using such a recovery filter, that is, the computation of equation (4), is not performed for all the regions of the image but is performed for only a region determined as a region suitable for recovery processing. Image recovery processing for each region in this embodiment will be described in detail below.

(Image Recovery Processing for Each Region)

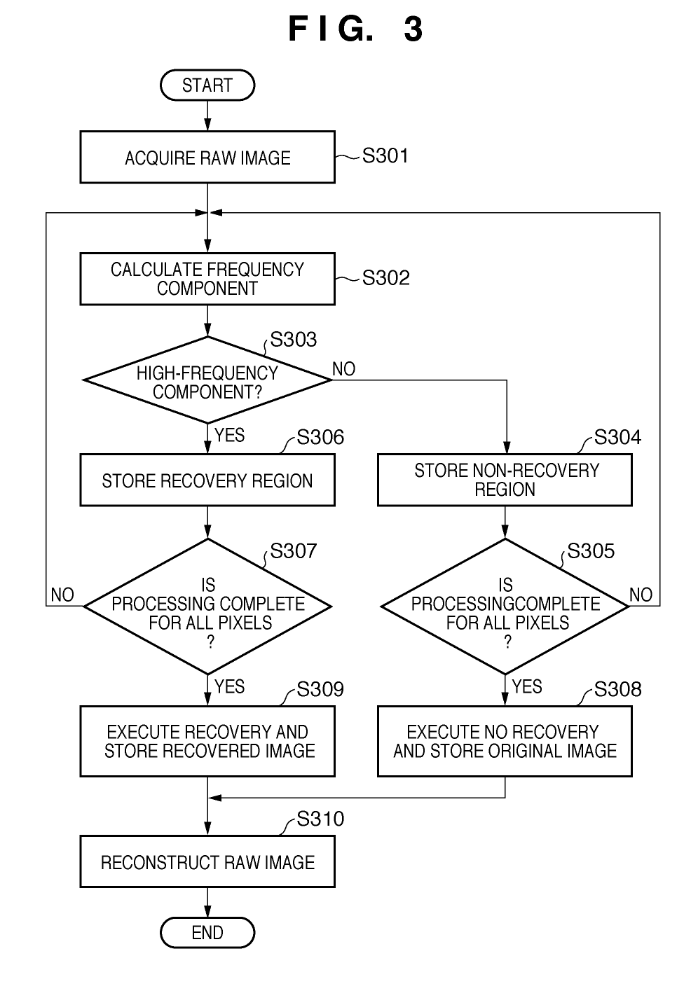

FIG. 3 is a flowchart showing recovery processing performed in the image recovery unit 107 for each region. The region dividing unit 117 performs the processing in steps S301 to S307, and the recovery processing unit 118 then performs the processing in steps S308 to S310.

In step S301, the region dividing unit 117 acquires a raw image from the A/D conversion unit 106. In step S302, the region dividing unit 117 starts calculating a frequency component from a corner of the image.

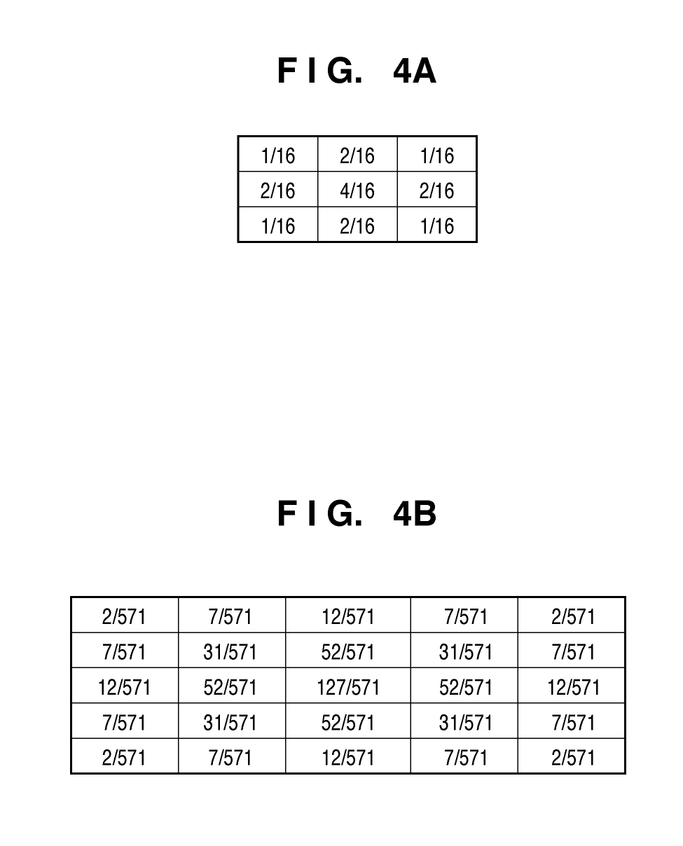

It is possible to calculate a frequency component for each pixel by, for example, performing two-dimensional Fourier transform for a predetermined peripheral region centered on the pixel of interest. The region dividing unit 117 then calculates the amount of components of equal to or higher than a predetermined spatial frequency. Another method is to calculate high-frequency components by calculating differences from the original image after convolution. That is, the region dividing unit 117 performs convolution for the original image by using a blur filter such as a 3×3 or 5×5 Gaussian filter kernel shown in FIGS. 4A and 4B. In this case, it is necessary to separate the R, G, and B pixels of the raw image, which constitute a Bayer arrangement, for each color in advance. With this convolution processing, the region dividing unit 117 performs low-pass filter processing of the original image to remove high-frequency components. The region dividing unit 117 calculates high-frequency components by calculating the differences between the resultant image and the original image.

In this raw image, since the high-frequency component in an in-focus region increases, the region dividing unit 117 determines, in step S303, the presence/absence of a high-frequency component by comparing the frequency component calculated in step S302 with a predetermined threshold. That is, if the frequency component is less than the threshold, the region dividing unit 117 determines that there is no high-frequency component, that is, the region is not in focus. The flow then advances to step S304. If the frequency component is equal to or more than the threshold, the region dividing unit 117 determines that an in-focus state is obtained. The flow then advances to step S306. It is possible to adaptively set a threshold in this case in accordance with the characteristics of the objective lens 102. For example, it is preferable to set a high threshold when this apparatus uses a wide-angle lens with a large depth of field or has a large F number value, whereas it is preferable to set a low threshold when the apparatus uses a focusing lens with a small depth of field or has a small F number value. In addition, it is possible to set a threshold which changes in direction proportionally to the amount of axial chromatic aberration.

In step S304, the region dividing unit 117 records the central pixel position of the convolution kernel as a non-recovery region on the recovery region storage unit 119. In step S305, the region dividing unit 117 determines whether the processing for all the pixels is complete. If the processing is complete, the process advances to step S308. If the processing is not complete, the process returns to step S302. In step S308, the recovery processing unit 118 stores the pixel value of the original image of the non-recovery region in the original image storage unit 121. The process then advances to step S310.

In step S306, the region dividing unit 117 records the central pixel position of the convolution kernel as a recovery region on the recovery region storage unit 119. In step S307, the region dividing unit 117 determines whether the processing for all the pixels is complete. If the processing is complete, the process advances to step S309. If the processing is not complete, the process returns to step S302. In step S309, the recovery processing unit 118 executes the above image recovery for the image of the recovery region, and stores the result in the recovered image storage unit 120. The process then advances to step S310.

In step S310, the recovery processing unit 118 reads out the original image and the recovered image from the original image storage unit 121 and the recovered image storage unit 120, respectively, and combines the two images to reconstruct a raw image. This reconstructed raw image is the raw image after recovery, which has undergone recovery processing only in the in-focus region, that is, an object portion at the distance optimal for the recovery filter in use.

The above description relates to the case in which an original image is divided into a recovery region and a non-recovery region. However, since no specific transition region is provided at the boundary between the two regions, there is a possibility that the recovered image in the recovery region may become discontinuous with the original image in the non-recovery region after combining operation. In order to avoid the occurrence of such discontinuity, this embodiment performs the following processing.

First of all, recovery processing in the spatial domain is performed as indicated by equation (4) given above. Equation (3) given above represents recovery processing in the frequency domain performed by Fourier transform expressed by equation (4). In this case, a factor α is added to equation (3) to obtain equation (5):

G(u,v)/{H(u,v)/α}=F(u,v) (5)

Obviously, if α=H(u, v) in equation (5), the apparatus does not perform substantial recovery, whereas if α=1, the apparatus performs predetermined recovery equivalent to equation (4). In this manner, changing the value of a can change H(u, v). That is, controlling OTF can smoothly change the degree of recovery between regions. This embodiment, therefore, changes a in the range from H(u, v) (less than 1) to 1 in equation (5).

More specifically, the apparatus performs control, in accordance with the distance from a boundary of a pixel of interest in a recovery region, to set α=H(u, v) if, for example, the distance is 0, bring α closer to 1 as the distance increases to a predetermined value that makes it necessary to perform boundary control, and always set α=1 when the distance becomes equal to or more than the predetermined value. In other words, if the distance is smaller than the predetermined value, the apparatus performs control to decrease the degree of recovery processing as the distance decreases. Alternatively, the apparatus performs control in accordance with the calculated frequency component to set α=H(u, v) if, for example, the frequency component is equal to the threshold in step S303. While the distance in the recovery region becomes the predetermined value that makes it necessary to perform boundary control, the apparatus performs control to bring a closer to 1 with an increase in the frequency component and always set α=1 when the distance becomes equal to or more than the predetermined value, as well as controlling α in accordance with the distance. In other words, the apparatus performs control to decrease the degree of recovery processing as the frequency component decreases in a region within a recovery region, in which the amount of recovery is to be changed smoothly, when the frequency component is smaller than the predetermined value.

Based on a viewpoint different from that described above, it is also possible to perform control in consideration of pixel values in a recovery region so as to suppress the degree of recovery to a predetermined amount of recovery or less. In a region in which the average value of pixel values is small, that is, the luminance of an object is low, when the amplitude of a high-frequency component increases due to recovery processing, the lower end of the amplitude may become smaller than the lower limit that each pixel value can take. When the computed pixel value after recovery processing is smaller than the lower limit, the pixel value is clipped to the lowest value. At this time, an obvious pseudo contour is generated between a portion which is clipped to black and a portion which is not clipped. In order to prevent this, when the average of pixel values is close to the lowest value of the pixel values, it is necessary to suppress an increase in amplitude due to recovery processing. That is, the apparatus controls the mechanism of gradually changing the degree of recovery at the boundary between a recovery region including high frequencies and a non-recovery region, in accordance with the average of local pixel values.

More specifically, the apparatus calculates the average value of the pixel values including those of predetermined pixels surrounding a pixel of interest, and changes α=H(u, v) to α=1 in accordance with the difference between the average value and the lowest pixel value. The expression relating them may be linear or nonlinear. In addition, it is possible to set an average pixel value for predetermined recovery with α=1, in accordance with the characteristics of the image capturing apparatus.

In addition, giving factors between α=H(u, v) and α=1 to a region to which no recovery has been performed upon setting α=H(u, v) also makes it possible to perform weak recovery processing for a region other than a recovery region.

Note that in actual recovery processing, the apparatus calculates the recovery filter r(x, y) represented by equation (4) in accordance with a set in equation (5), and uses the calculated filter. That is, the recovery filter storage unit 116 stores a plurality of recovery filters calculated in advance in accordance with α. The apparatus selects a recovery filter matching a parameter such as the distance from a boundary of a pixel of interest in a recovery region or a frequency component.

This embodiment can reduce discontinuity at the boundary between a recovered image and an original image and smoothly connect the two regions by controlling H(u, v) in equation (5), that is, OTF, based on α in this manner. In addition, it is possible to apply the dither method, error diffusion method, or the like to the boundary portion between a recovered image and an original image.

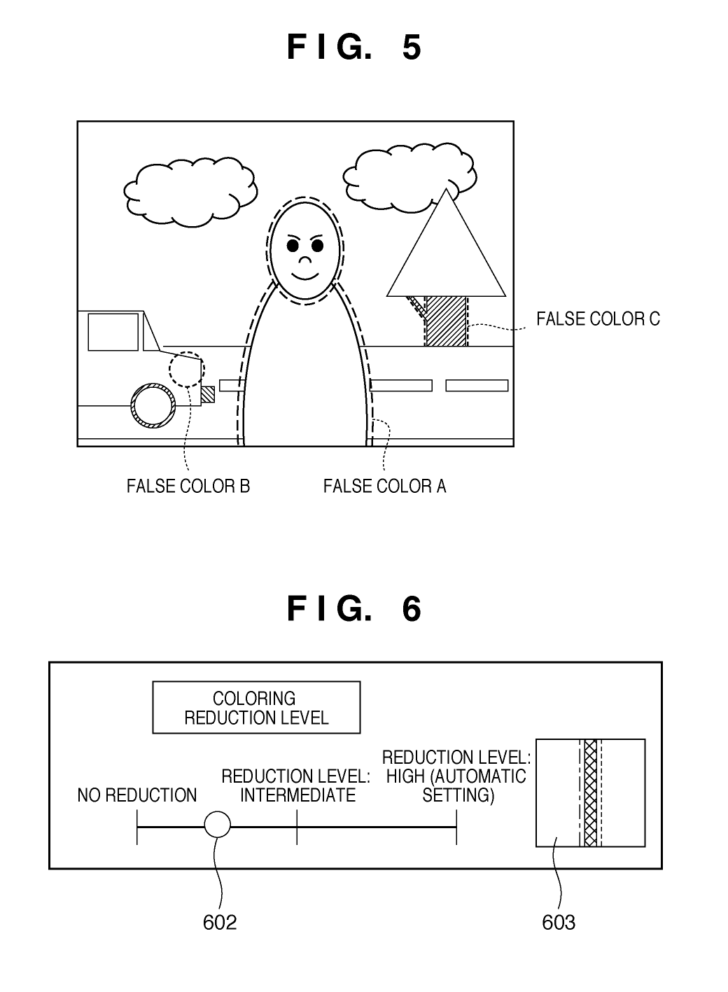

The effects of image recovery processing in this embodiment will be described below with reference to FIG. 5. The image shown in FIG. 5 is obtained by capturing an image of a person at a short distance using a large aperture (i.e. a small aperture value/F number), with the eyes of the person being in focus. For this reason, portions other than those at the same distance as the eyes of the person in the image are out of focus. Images of these portions are therefore captured with blur. In this case, performing recovery processing for all the regions by using a recovery filter corresponding to the focusing distance will generate the following false colors. First of all, a false color A due to chromatic aberration is generated at the contour portions of the face and body which are slightly blurred because they slightly deviate from the focusing distance. In addition, since the pixel values are saturated on a specularly reflecting portion of the body of the car in the background, it is impossible to obtain correct pixel information necessary for recovery. For this reason, coloring (a false color B) occurs. Furthermore, a ringing false color C is generated at an edge portion of the tree whose object distance greatly deviates from the focusing distance because of the influence of the application of a recovery filter corresponding to a different focal length.

Applying this embodiment to the same captured image will recover only an image region including high-frequency components and will not recover the portions corresponding to the false colors A to C in FIG. 5. This therefore prevents the generation of the false colors A to C.

As described above, this embodiment is configured to extract a region having high-frequency components as a portion in focus in a captured image of an object, with a simple arrangement, without actually measuring the object distance, and perform recovery processing for only the extracted region. Since the embodiment performs no recovery processing for a region differing in focusing distance from the recovery filter, it is possible to improve image quality while suppressing the problem of the generation of a false color in the region.

The above embodiment has exemplified the case in which a frequency component threshold for dividing between a recovery region and a non-recovery region is fixed and the case in which a threshold is set in accordance with the optical characteristics of the objective lens 102. Setting this threshold sets a tradeoff between an improvement in sharpness by recovery and the amount of generation of false colors. It is therefore useful to allow the user to select such a threshold.

The following embodiment will exemplify a case in which the user sets a threshold used for the determination in step S303 via a GUI (Graphical User Interface).

FIG. 6 shows an example of a GUI for threshold adjustment by the user. Changing a threshold for the extraction of a region containing high-frequency components will set a false color reduction level. Referring to FIG. 6, reference numeral 602 denotes a slide bar to set a threshold. Setting the slide bar 602 at the left end will inhibit coloring reduction. That is, this setting will set the threshold to 0, which is the minimum value of a frequency component, to perform recovery processing for all the regions in a conventional manner without performing recovery processing for each region as in this embodiment. When the user sets the slide bar 602 at the right end, the threshold is set to a predetermined value to perform processing with a recovery region being automatically set as in the embodiment. The user can therefore arbitrarily set the threshold between 0 and a predetermined value by sliding the slide bar 602 between the left end and the right end. Assume that the slide bar 602 is set at the right end in the default state.

Reference numeral 603 denotes an effect check window to display a processing result on a specific portion of an image. Assume that the effect check window 603 displays a state in which the slide bar 602 is set at the right end, that is, the result obtained by performing recovery processing in this embodiment, in the default state. It is preferable to select a portion susceptible to the generation of a false color as a specific portion of an image which is a display target on the effect check window 603. However, a display target is not limited to a portion of an image, and the window may display a processing result on a specific sample image which is assumed to be displayed.

As has been described above, this embodiment allows the user to select a recovery state optimal for the purpose.

### Other Embodiments

Note that it is possible to use a bilateral filter for the calculation of frequency components in the above embodiment. More specifically, such a filter is described in F. Durand and J. Dorsey, “Fast Bilateral Filtering for Display of High-Dynamic-Range Images”, SIGGRAPH2002. That is, this filter is a blur filter to hold an edge by forming a filter kernel based on two components including a component corresponding to the distance from a pixel of interest (which is synonymous with a simple Gaussian filter) and a component corresponding to the difference in pixel value from the pixel of interest. Using such a bilateral filter can divide an image into small regions surrounded with edges and calculate frequency components in the respective regions as in the embodiment. This makes it possible to more accurately obtain a portion in an image which matches the focal length.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-272803, filed Nov. 30, 2009, which is hereby incorporated by reference herein in its entirety.

What is claimed is:

1. An image capturing apparatus comprising:
an image sensing unit configured to obtain a captured image by capturing an image of an object;
a dividing unit configured to calculate a frequency component of each pixel of the captured image and divide the pixels into pixels in a recovery region, whose frequency components are not less than a predetermined threshold, and other pixels in a non-recovery region;
a recovery unit configured to perform recovery processing for a pixel in the recovery region to correct degradation of image quality caused by optical characteristics of said image sensing unit; and
a combining unit configured to reconstruct the captured image by combining pixels in the recovery region for which the recovery processing has been performed with pixels in the non-recovery region.

2. The apparatus according to claim 1, wherein said dividing unit calculates a frequency component of each pixel by performing convolution for the captured image and calculating differences between the image after the convolution and the captured image.

3. The apparatus according to claim 1, wherein said dividing unit calculates a frequency component of each pixel by performing a two-dimensional Fourier transform for a region of the captured image, which is centered on a pixel of interest.

4. The apparatus according to claim 1, wherein said dividing unit divides the captured image into regions surrounded with edges by applying a bilateral filter to the captured image and calculates a frequency component for each of the regions.

5. The apparatus according to claim 1, wherein said recovery unit performs recovery processing by using an optical transfer function of said image sensing unit.

6. The apparatus according to claim 5, further comprising an acquisition unit configured to acquire a focal length of said image sensing unit,
wherein said recovery unit performs recovery processing using a recovery filter corresponding to the focal length acquired by said acquisition unit.

7. The apparatus according to claim 6, further comprising a holding unit configured to hold a plurality of said recovery filters,
wherein said recovery unit selects one of said plurality of recovery filters held by said holding unit in accordance with the focal length, and performs recovery processing using the selected recovery filter.

8. The apparatus according to claim 5, wherein said recovery unit performs control to decrease a degree of recovery processing for each pixel in the recovery region, when a distance to the non-recovery region is smaller than a predetermined value, as the distance decreases.

9. The apparatus according to claim 5, wherein said recovery unit performs control to decrease a degree of recovery processing for each pixel in the recovery region, when the frequency component is smaller than a predetermined value, as the frequency component decreases.

10. The apparatus according to claim 1, further comprising a setting unit configured to set the threshold in said dividing unit in accordance with a user instruction.

11. An image processing method in an image capturing apparatus, comprising the steps of:
obtaining a captured image by capturing an image of an object;
calculating a frequency component of each pixel of the captured image;
dividing the captured image by setting pixels whose frequency components calculated in the calculation step are not less than a predetermined threshold as pixels belonging to a recovery region and other pixels as pixels belonging to a non-recovery region;
performing recovery processing for a pixel in the recovery region to correct degradation of image quality caused by optical characteristics of the image capturing apparatus; and
reconstructing the captured image by combining pixels in the recovery region for which the recovery processing has been performed with pixels in the non-recovery region.
